(19) United States
(12) Patent Application Publication
(10) Pub. No.: US 2022/0061060 A1
(43) Pub. Date: Feb. 24, 2022

(54) RADIO COMMUNICATION

(71) Applicant: Nordic Semiconductor ASA, Trondheim (NO)

(72) Inventors: Hanna-Liisa TIRI, Trondheim (NO); Mauri NISSILÄ, Trondheim (NO)

(73) Assignee: Nordic Semiconductor ASA, Trondheim (NO)

(21) Appl. No.: 17/413,418

(22) PCT Filed: Dec. 11, 2019
(86) PCT No.: PCT/EP2019/084739

§ 371 Date: Jun. 11, 2021

(30) Foreign Application Priority Data
Dec. 11, 2018 (GB) 1820177.2

(51) Int. Cl. H04W 72/08; H04W 4/70

(52) U.S. Cl. CPC H04W 72/085; H04B 17/318; H04W 4/70

(57) ABSTRACT

A method of operating a radio receiver having a normal mode in which said radio receiver is arranged to seek information by continually monitoring search space candidates and a rejection mode in which said radio receiver stops monitoring one or more of the candidates. The method comprises receiving at least one signal comprising a portion specified in the protocol for carrying a non-universal reference symbol; determining a first received signal strength value of said portion; receiving at least one signal carrying a universal reference symbol; determining a second received signal strength value of said universal reference symbol; comparing the first received signal strength value to a signal strength threshold based on the second received signal strength value; operating the radio receiver in the normal mode if the first received signal strength value exceeds the signal strength threshold; and operating the radio receiver in the rejection mode if the first received signal strength value does not exceed the signal strength threshold.

### TECHNICAL FIELD

The present invention relates to receiving data packets via a radio communications network, particularly, although not exclusively, a cellular network such as a Long Term Evolution (LTE) network.

### BACKGROUND

In recent years, the extent and technical capabilities of cellular-based radio communication systems have expanded dramatically. A number of different cellular-based networks have been developed over the years, including the Global System for Mobile Communications (GSM), General Packet Radio Services (GPRS), Enhanced Data rates for GSM Evolution (EDGE), and Universal Mobile Telecommunications System (UMTS), where GSM, GPRS, and EDGE are often referred to as second generation (or “2G”) networks and UMTS is referred to as a third generation (or “3G”) network.

More recently, the Long Term Evolution (LTE) network, a fourth generation (or “4G”) network standard specified by the 3^{rd} Generation Partnership Project (3GPP), has gained popularity due to its relatively high uplink and downlink speeds and larger network capacity compared to earlier 2G and 3G networks. More accurately, LTE is the access part of the Evolved Packet System (EPS), a purely Internet Protocol (IP) based communication technology in which both real-time services (e.g. voice) and data services are carried by the IP protocol. The air interface of LTE is often referred to as Evolved UMTS Terrestrial Radio Access (or “E-UTRA”).

However, while “classic” LTE connections are becoming increasingly prevalent in the telecommunications industry, further developments to the communication standard are being made in order to facilitate the so-called “Internet of Things” (IoT), a common name for the inter-networking of physical devices, sometimes called “smart devices”, providing physical objects that may not have been connected to any network in the past with the ability to communicate with other physical and/or virtual objects. Such smart devices include: vehicles; buildings; household appliances, lighting, and heating (e.g. for home automation); and medical devices.

These smart devices are typically real-world objects with embedded electronics, software, sensors, actuators, and network connectivity, thus allowing them to collect, share, and act upon data. These devices may communicate with user devices (e.g. interfacing with a user's smartphone) and/or with other smart devices, thus providing “machine-to-machine” (or “machine type”) communication. However, the development of the LTE standards makes it more practical for them to connect directly to the cellular network.

3GPP have specified two versions of LTE for such purposes in Release 13 of the LTE standard. The first of these is called “NarrowBand IoT” (NB-IoT), sometimes referred to as “LTE Cat NB1”, and the second is called “enhanced Machine Type Communication” (eMTC), sometimes referred to as “LTE Cat M1”. It is envisaged that the number of devices that utilise at least one of these standards for IoT purposes will grow dramatically in the near future.

From a communications perspective, LTE standards (including NB-IoT and eMTC) use orthogonal frequency division multiple access (OFDMA) as the basis for allocating network resources. This allows the available bandwidth between to be shared between user equipment (UE) that accesses the network in a given cell, provided by a base station, referred to in LTE as an “enhanced node B”, “eNodeB”, or simply “eNB”. OFDMA is a multi-user variant of orthogonal frequency division multiplexing (OFDM), a multiplexing scheme known in the art per se.

At the physical layer, in the downlink of an LTE connection, each data frame is 10 ms long and is constructed from ten sub-frames, each of 1 ms duration. Each sub-frame contains two slots of equal length, i.e. two 0.5 ms slots. Each slot (and by extension, each sub-frame and each frame) will typically contain a certain number of “resource blocks” (where each sub-frame has twice as many resource-blocks as a slot and each frame has ten times as many resource blocks as a sub-frame). A resource block is 0.5 ms long in the time domain and is twelve sub-carriers wide in the frequency domain. Generally speaking, there are seven OFDM symbols per slot and thus fourteen OFDM symbols per sub-frame, though this may vary. For example if the ‘extended cyclic prefix (CP)’ defined in eMTC is in use, there may be six OFDM symbols per slot and twelve OFDM symbols per sub-frame.

These resource blocks can be visualised as a grid of “resource elements”, where each resource element is 1/14 ms long and one sub-carrier wide, such that there are eighty-four resource elements per resource block (i.e. seven multiplied by twelve in the case of normal cyclic prefix) and one hundred and sixty-eight resource elements per sub-frame.

In addition to conveying data, these resource elements may be used to carry “reference symbols” (RS), where these RS are used to aid demodulation. Those skilled in the art will appreciate that the terms used for these RS depend on the specific LTE protocol in use—for example, NB-IoT communications use “narrowband reference symbols” (NRS) and, in some cases such as in the in-band mode of NB-IoT, “common reference symbols” (CRS)—a reference symbol type used by legacy LTE modes. In noisy conditions it may be necessary to average or filter a number of these RS in order to obtain a suitable “channel estimate”, i.e. an estimate of the characteristics of the channel such as attenuation, phase shifts, and noise. Those skilled in the art will appreciate that these RS, or filtered RS, are then used for channel equalisation and for demodulation, e.g. to aid the demodulation of the OFDM data symbols. Typically, an LTE eNodeB is arranged to transmit RS continually (e.g. periodically), regardless of whether or not it has any data to send at any given time and regardless of which UE any such data is intended for.

Conversely, eMTC communications use a further type of reference symbol known as a Demodulation Reference Symbol (DMRS). These DMRS are used as a reference signal for demodulation of signals received when operating in accordance with the eMTC protocol. In addition to DMRS, eMTC communications also make use of CRS which, according to the eMTC protocol, are always transmitted (unlike in NB-IoT, in which CRS may be available only in the in-band mode of operation).

Release 13 of the LTE standard introduced coverage enhancement for ‘Bandwidth Reduced Low Complexity’ (BL) and ‘Coverage Enhancement’ (CE) UEs by providing for repetition in physical downlink channels, in particular the physical downlink shared channel (PDSCH) and the MTC physical downlink control channel (MPDCCH).

The repetition of data on these channels is carried out across multiple sub-frames and is designed to provide an averaging gain when the signal power is low, i.e. when the signal-to-noise ratio (SNR) is low. There are two modes of coverage enhancement defined in the standard, ‘Class A’ and ‘Class B’. Class A is a mandatory feature that defines a moderate number of repetitions while Class B is an optional feature that defines a higher number of repetitions. The maximum number of repetitions in Class A is 32 for PDSCH while the maximum number of repetitions in Class B is 2048 for PDSCH.

Similarly, in NB-IoT communications, the narrowband physical downlink shared channel (NPDSCH) may provide for a maximum of 2048 repetitions.

The actual number of repetitions N (e.g. of the PDSCH sub-frames) used is defined by the standard but is typically variable. The number of repetitions being used by the eNB is signaled in the downlink control information (DCI) and is typically selected based on various channel quality metrics, known in the art per se, which will typically vary during operation.

A typical BL/CE UE operating in accordance with the standard is arranged to decode the data symbols repeated across the repeated sub-frames once all of the repetitions have been received, by combining the various repetitions to obtain an improvement in the SNR prior to decoding. However, the Applicant has appreciated that such devices may, in some cases, consume more power than is necessary by operating in this way.

In particular, when BL/CE UE or non BL/CE UE is supporting the release 13 CE Mode A/Ce Mode B, i.e. repetitions or NB-IOT UE, downlink control channel monitoring and reception of data channel with long repetitions is consuming batteries of the device. Blind decoding of downlink control channel is required all the time when configured even if there is no control or data channel transmission for the UE.

### SUMMARY OF THE INVENTION

When viewed from a first aspect, the present invention provides a method of operating a radio receiver in accordance with a protocol, the radio receiver having a normal mode in which said radio receiver is arranged to seek information by continually monitoring a plurality of search space candidates and a rejection mode in which said radio receiver stops monitoring one or more of said candidates, said method comprising:
receiving at least one signal comprising a portion specified in the protocol for carrying a non-universal reference symbol;
determining a first received signal strength value of said portion;
receiving at least one signal carrying a universal reference symbol;
determining a second received signal strength value of said universal reference symbol;
comparing the first received signal strength value to a signal strength threshold based on the second received signal strength value;
operating the radio receiver in the normal mode if the first received signal strength value exceeds the signal strength threshold; and
operating the radio receiver in the rejection mode if the first received signal strength value does not exceed the signal strength threshold.

This first aspect of the invention extends to a radio receiver arranged to operate in accordance with a protocol, the radio receiver having a normal mode in which said radio receiver is arranged to seek information by continually monitoring a plurality of search space candidates and a rejection mode in which said radio receiver is arranged to stop monitoring one or more of said candidates, said radio receiver being further arranged to:
receive at least one signal comprising a portion specified in the protocol for carrying a non-universal reference symbol;
determine a first received signal strength value of said portion;
receive at least one signal carrying a universal reference symbol;
determine a second received signal strength value of said universal reference symbol;
compare the first received signal strength value to a signal strength threshold based on the second received signal strength value;
operate in the normal mode if the first received signal strength value exceeds the signal strength threshold; and
operate in the rejection mode if the first received signal strength value does not exceed the signal strength threshold.

This first aspect of the invention also extends to a radio communication system comprising a radio transmitter and a radio receiver arranged to operate in accordance with a protocol, the radio receiver having a normal mode in which said radio receiver is arranged to seek information by continually monitoring a plurality of search space candidates and a rejection mode in which said radio receiver stops monitoring one or more of said candidates, said radio receiver being further arranged to:
receive at least one signal comprising a portion specified in the protocol for carrying a non-universal reference symbol;
determine a first received signal strength value of said portion;
receive at least one signal carrying a universal reference symbol;
determine a second received signal strength value of said universal reference symbol;
compare the first received signal strength value to a signal strength threshold based on the second received signal strength value;
operate in the normal mode if the first received signal strength value exceeds the signal strength threshold; and
operate in the rejection mode if the first received signal strength value does not exceed the signal strength threshold.

This first aspect of the invention further extends to a non-transitory computer-readable medium comprising instructions that, when executed by a processor, cause the process to carry out a method of operating a radio arranged to operate in accordance with a protocol such that said radio receiver:
receives at least one signal comprising a portion specified in the protocol for carrying a non-universal reference symbol;
determines a first received signal strength value of said portion;
receives at least one signal carrying a universal reference symbol;
determines a second received signal strength value of said universal reference symbol;
compares the first received signal strength value to a signal strength threshold based on the second received signal strength value;
operates in the normal mode if the first received signal strength value exceeds the signal strength threshold; and
operates in the rejection mode if the first received signal strength value does not exceed the signal strength threshold.

Thus it will be appreciated by those skilled in the art that, unlike the conventional approach, a radio receiver operated in accordance with embodiments of the present invention may check for an indication of incoming data symbols addressed to the radio receiver since a comparison of the relative signal strengths of the non-universal and universal reference symbols may yield an indication as to the presence or absence of data symbols addressed to the radio receiver, e.g. a DCI message. If no such indication is seen, the receiver may stop monitoring one or more search space candidates earlier than it would have otherwise done following conventional approaches and thereby save power.

The signal strength threshold is based on the received signal strength of the universal reference symbol. In at least some embodiments, the signal strength threshold is simply the second received signal strength, i.e. the received signal strength of the universal reference symbol. However, it will be appreciated that the signal strength threshold may instead be determined from the second received signal strength to account for a known power offset between the universal and non-universal reference symbols (if these are not, for example, transmitted at the same power) and/or for a known difference in a transmission antenna mapping between the non-universal and universal reference symbols. If the signal strength threshold is not equal to the second received signal strength, there may be a predetermined relationship between the signal strength threshold and the second received signal strength, e.g. the signal strength threshold may be proportional to the second received signal strength. By way of non-limiting example, if it is known that, for some reason, the non-universal symbol is transmitted only at 80% of the power that the universal symbol is transmitted at, the signal strength threshold may be determined as 80% of the second received signal strength value. It will, however, be appreciated that this relationship may not necessarily be proportional, e.g. there may be an offset.

The received signal strength of the universal reference symbol, which is typically continually transmitted by the network regardless of whether it is transmitting data symbols addressed to the radio receiver, is thus used as (or at least used to set) a ‘benchmark’ against which the received signal strength of the non-universal reference symbol is compared in order to determine the likely presence or absence of data symbols addressed to the radio receiver. This may advantageously make the radio receiver operating in accordance with the embodiments of the present invention robust to varying operating conditions.

For example, a radio receiver will likely have a greater received signal strength of the universal reference symbol when it is close to the transmitter (e.g. to an LTE eNB) than when the radio receiver is far from the transmitter; however, having a greater received signal strength of the universal reference symbol increases the benchmark received signal strength that the portion specified for the non-universal reference symbol must reach for search space candidate monitoring to continue (i.e. false positives due to high received signal strengths may be avoided).

Conversely, weaker received non-universal reference symbols advantageously may not be inadvertently discarded because the received signal strength that the radio receiver requires of the portion specified for the non-universal reference symbol is reduced when the received signal strength of the universal reference symbol is reduced.

In a set of embodiments, the step of operating the radio receiver in the normal operating mode comprises:
performing a decoding attempt on a selected search space candidate of said one or more search space candidates.

As will be understood by those skilled in the art, decoding a candidate typically comprises trying to extract digital data therefrom using any one or a number of techniques well know per se in the art, just one non-limiting example of which is a Viterbi decoder. Typically, successful decoding is determined by applying any one or more of a number of error or integrity checks such as a cyclic redundancy check (CRC).

Attempts to decode the received data may be carried out, for example using different search space candidates. As the radio receiver does not typically know the particular format being used to transmit messages, such as downlink control information messages, one or more of these formats are used as candidates and a decoding attempt is carried out as if the particular format associated with a given candidate is in use.

In at least some such embodiments, operating the radio receiver in the normal mode comprises subsequently stopping monitoring of the selected search space candidate if the decoding attempt fails. Thus the rejection mode may be subsequently entered if the decoding fails despite the positive indication from the signal strength value comparison. The decoding attempt could be a first decoding attempt—i.e. monitoring is stopped as soon as decoding fails. In a subset of such embodiments however the method comprises:
receiving a further repetition of said selected search space candidate; and
said decoding attempt is a second or subsequent decoding attempt performed on said further repetition.

This allows for one or more ‘re-checks’ to be carried out before the candidate is discarded. Whilst this may be associated with a slight increase in power consumption compared to the case where only decoding attempt is carried out, it may reduce the risk of false negatives and still of course allows the significant benefits in power saving which may be achievable in accordance with implementation of the invention generally.

In a potentially overlapping set of embodiments, operating the radio receiver in the normal mode comprises:
performing a decoding attempt on a selected search space candidate of said one or more search space candidates, wherein a successful decoding attempt produces a downlink control information message; and
accepting the downlink control information message if the decoding attempt is successful.

It will be appreciated that some communication protocols have different modes of operation. By way of non-limiting example, a transmitter operating in accordance with at least some LTE-based communication protocols may operate in a mode in which it transmits paging DCI messages at specific points in time in accordance with the protocol. However, such a transmitter may additionally or alternatively operate in a UE-specific search space (USS) and/or ‘random access’ mode in which the times when DCI messages are transmitted by the network may vary. As will be appreciated by those skilled in the art, random access, USS, and paging are procedures that are known in the art per se (e.g. as defined in the radio resource control (RRC) and/or medium access control (MAC) procedures in the 3GPP specification).

‘Random access’ may be carried out, for example, when uplink timing is lost, at the beginning of normal ‘Connected Mode’ transmission (random access typically starts the procedure of moving to connected mode). During the data transmission, the eNodeB may detect that synchronisation has been lost, and instruct a UE to carry out the random access procedure with a special DCI message.

When a UE is in the Connected Mode, it typically monitors USS after the random access procedure is complete. During the random access procedure, one type of common search space (CSS) for random access is typically monitored. Paging monitoring is another kind of CSS, where the parametrisation is such that all candidates from the beginning of the search space are monitored.

Generally, when the UE has no data packets to transmit (via the uplink) or receive (via the downlink) in the Connected Mode, the UE is released to Idle Mode. When in the Idle Mode, i.e. during the idle periods, paging is carried out.

Thus in a set of such embodiments, operating the radio receiver in the normal mode further comprises:
determining whether an unstructured mode is enabled;
accepting the downlink control information message and subsequently receiving one or more data sub-frames if the decoding attempt is successful and the unstructured mode is not enabled; and
accepting the downlink control information message and subsequently stopping monitoring of all current search space candidates when the decoding attempt is successful and the unstructured mode is enabled.

The ‘unstructured mode’ referred to hereinabove may, at least in some embodiment be a random access mode or a user specific search space mode. Generally, if a random access or paging search space DCI is received, then all the other monitoring may be stopped. Data sub-frames corresponding the accepted DCI may be received. The amount and allocation of such data sub-frames may be determined from RRC configuration with the help of DCI fields in a manner known in the art per se.

Those skilled in the art will appreciate that there are many ways, known in the art per se, to enumerate the received signal strength of a received signal, for example an absolute value of amplitude or an absolute value of signal power could be used. However, in at least some embodiments, the first and/or second received signal strength values comprise a respective signal-to-noise ratio (SNR). Thus, in accordance with such embodiments, the SNR of the portion that may contain a non-universal reference symbol is compared to what is effectively a target SNR, where that target SNR is the SNR of the universal reference symbol.

The principles of the present invention may be readily applied to any suitable radio communication protocol; however, the Applicant has appreciated that it is particularly advantageous for cellular telecommunication protocols. In a set of preferred embodiments, the protocol comprises an LTE radio communication protocol. In a particularly preferred set of embodiments, the protocol comprises a machine-to-machine LTE radio communication protocol.

As outlined above, one type of machine-to-machine LTE radio communication protocol outlined in the 3GPP specification is NB-IoT. In a set of embodiments, the protocol is NB-IoT and the non-universal reference symbol comprises a narrowband reference symbol (NRS).

In some alternative embodiments, the protocol is eMTC and the non-universal reference symbol comprises a demodulation reference symbol (DMRS).

Regardless of whether NB-IoT, eMTC, or some other protocol is in use, the Applicant has appreciated that there may be reference symbols that are present, regardless of whether the UE is being paged, or if a paging occasion is even taking place, and these reference symbols are the ‘universal’ reference symbols referred to herein. One such type of universal reference symbol is a CRS. Thus in some embodiments, the universal reference symbol comprises a common reference symbol (CRS). Thus, in accordance with a set of embodiments, the CRS are compared to NRS (e.g. in NB-IoT systems) or to DMRS (e.g. in eMTC systems).

The Applicant has appreciated that there may be more than one potential cause of a failed decoding attempt. In some embodiments, the method comprises:
performing a decoding attempt on at least one search space candidate;
calculating a candidate signal strength value associated with the at least one search space candidate and comparing said candidate signal strength value to a threshold; and
operating the radio receiver in the rejection mode if the search space candidate decoding attempt fails and the candidate signal strength value is greater than said threshold.

This is novel and inventive in its own right and thus when viewed from a second aspect, the present invention provides a method of operating a radio receiver in accordance with a protocol, said method comprising:
performing a decoding attempt on at least one search space candidate, wherein a successful decoding attempt produces a downlink control information message;
calculating a candidate signal strength value associated with the at least one search space candidate and comparing said candidate signal strength value to a threshold when the search space candidate decoding attempt fails; and
stopping monitoring the search space candidate if the decoding attempt fails and the candidate signal strength value is greater than said threshold.

This second aspect of the invention extends to a radio receiver arranged to operate in accordance with a protocol, said radio receiver being arranged to:
perform a decoding attempt on at least one search space candidate, wherein a successful decoding attempt produces a downlink control information message;
calculate a candidate signal strength value associated with the at least one search space candidate and to compare said candidate signal strength value to a threshold when the search space candidate decoding attempt fails; and
stop monitoring the search space candidate if the decoding attempt fails and the candidate signal strength value is greater than said threshold.

This second aspect of the invention also extends to a radio communication system comprising a radio transmitter and a radio receiver arranged to operate in accordance with a protocol, said radio receiver being arranged to:
perform a decoding attempt on at least one search space candidate, wherein a successful decoding attempt produces a downlink control information message;
calculate a candidate signal strength value associated with the at least one search space candidate and to compare said candidate signal strength value to a threshold when the search space candidate decoding attempt fails; and
stop monitoring the search space candidate if the decoding attempt fails and the candidate signal strength value is greater than said threshold.

This second aspect of the invention further extends to a non-transitory computer-readable medium comprising instructions that, when executed by a processor, cause the process to carry out a method of operating a radio receiver arranged to operate in accordance with a protocol such that said radio receiver:
performs a decoding attempt on at least one search space candidate, wherein a successful decoding attempt produces a downlink control information message;
calculates a candidate signal strength value associated with the at least one search space candidate and compares said candidate signal strength value to a threshold when the search space candidate decoding attempt fails; and
stops monitoring the search space candidate if the decoding attempt fails and the candidate signal strength value is greater than said threshold.

Thus it will be appreciated that, in accordance with this second aspect of the invention, a radio receiver may determine that the failed decoding attempt is not due to signal strength conditions, i.e. that the received signal is strong, but is just not destined for the radio receiver. In other words, the radio receiver may be confident that it is not simply failing to decode the message due to it being received with a weak signal strength, but can instead determine with relative confidence that the radio receiver is not the intended recipient of the message(s) it has received.

While this determination may be made straight away (i.e. once both the decoding attempt fails and the candidate signal strength value exceeds the threshold), the Applicant has appreciated that it may be advantageous in some situations to check an additional repetition. As such, in some embodiments the method comprises:
receiving a repetition of said at least one search space candidate;
performing at least two decoding attempts, on the at least one search space candidate and the repetition of said at least one search space candidate respectively;
calculating a later candidate signal strength value associated with:
   i) the repetition of the at least one search space candidate; or
   ii) a combination of the at least one search space candidate and the repetition of the at least one search space candidate;
comparing said later candidate signal strength value to a second threshold; and
stopping monitoring the search space candidate if the decoding attempt fails and the later candidate signal strength value is less than said second threshold.

Thus, if a failed decoding attempt is associated with a sufficiently strong signal multiple times, the receiver may be sure that it may stop monitoring one or more (and potentially all) search space candidates. The second threshold could be the same as the previously recited threshold (e.g. if applied independently to the repetition) but need not be. For example it could be an aggregate threshold (e.g. if applied to a combination of the candidate and its repetition.

As outlined above, a transmitter may operate in a UE-specific search space (USS) and/or ‘random access’ mode in which the times when DCI messages are transmitted by the network may vary. In a set of embodiments, the method further comprises:
determining whether an unstructured mode is enabled;
stopping monitoring of search space candidates having a respective duration longer than the duration of the at least one search space candidate if the unstructured mode is enabled; and
stopping monitoring of all current search space candidates if the unstructured mode is not enabled.

Thus, in accordance with such embodiments, if the radio receiver determines that the search space candidate is expected to contain e.g. a paging DCI message because the random access protocol is not in use, the radio receiver operating in accordance with these embodiments stops monitoring all current search space candidates. Preferably the radio receiver or a portion thereof thereafter enters a low power or sleep mode.

If the random access protocol is in use the radio receiver may still at least stop monitoring overlapping search space candidates that are longer in time than the one which could not be decoded because the receiver may determine that it is impossible for the network to send a DCI message to that radio receiver on those longer candidates because the physical resources that would be required are already being used, e.g. to send DCI messages to another paging group not containing the radio receiver.

In some embodiments, the threshold is a predetermined value. However, in an alternative set of embodiments, the threshold is variable. For example, the threshold may, at least in some embodiments, be user configurable. In a potentially overlapping set of embodiments, a value of the threshold is varied during operation of the radio receiver.

Similarly, in a potentially overlapping set of embodiments, the second threshold is a predetermined value. However, in an alternative set of embodiments, the second threshold is variable. For example, the second threshold may, at least in some embodiments, be user configurable. In a potentially overlapping set of embodiments, a value of the second threshold is varied during operation of the radio receiver.

This may, for example, advantageously allow the radio receiver to vary the threshold(s) that the candidate signal strength must meet in order for the receiver to continue monitoring the search space candidates as may be required.

In many radio communication protocols, including at least some LTE radio communication protocols, a ‘preamble’ sub-frame may be transmitted by the network. It will be appreciated by those skilled in the art that a ‘preamble’ sub-frame typically arrives earlier in time than one or more other sub-frames and/or has known content. In some embodiments of either of the foregoing aspects, the method further comprises:
receiving a preamble sub-frame;
calculating a preamble signal strength value associated with the preamble sub-frame and comparing said preamble signal strength value to a preamble threshold; and
stopping monitoring of all current search space candidates if the preamble signal strength value is less than the preamble threshold.

This is novel and inventive in its own right and thus when viewed from a third aspect, the present invention provides a method of operating a radio receiver in accordance with a protocol, said method comprising:
monitoring a plurality of search space candidates;
receiving a preamble sub-frame;
calculating a preamble signal strength value associated with the preamble sub-frame and comparing said preamble signal strength value to a preamble threshold; and
stopping monitoring of all current search space candidates if the preamble signal strength value is less than the preamble threshold.

This third aspect of the invention extends to a radio receiver arranged to operate in accordance with a protocol, said radio receiver being further arranged to:
monitor a plurality of search space candidates;
receive a preamble sub-frame;
calculate a preamble signal strength value associated with the preamble sub-frame and to compare said preamble signal strength value to a preamble threshold; and
stop monitoring of all current search space candidates if the preamble signal strength value is less than the preamble threshold.

This third aspect of the invention also extends to a radio communication system comprising a radio transmitter and a radio receiver arranged to operate in accordance with a protocol, said radio receiver being further arranged to:
monitor a plurality of search space candidates;
receive a preamble sub-frame;
calculate a preamble signal strength value associated with the preamble sub-frame and to compare said preamble signal strength value to a preamble threshold; and
stop monitoring of all current search space candidates if the preamble signal strength value is less than the preamble threshold.

This third aspect of the invention further extends to a non-transitory computer-readable medium comprising instructions that, when executed by a processor, cause the process to carry out a method of operating a radio receiver arranged to operate in accordance with a protocol such that said radio receiver:
monitors a plurality of search space candidates;
receives a preamble sub-frame;
calculates a preamble signal strength value associated with the preamble sub-frame and compares said preamble signal strength value to a preamble threshold; and
stops monitoring of all current search space candidates if the preamble signal strength value is less than the preamble threshold.

Thus it will be appreciated that, in accordance with this third aspect of the invention and at least some embodiments of the first and second aspects of the invention, a radio receiver may determine that it can stop monitoring all of its search space candidates very early, e.g. in a paging group monitoring process. If the received preamble sub-frame does not have sufficient signal strength, the radio receiver may advantageously determine that there are not currently any incoming signals that include DCI at all and stop monitoring of the search space candidates, potentially before any decoding attempts are performed at all. This may allow a significant power saving.

In some embodiments, the preamble threshold is a predetermined value. However, in an alternative set of embodiments, the preamble threshold is variable. For example, the preamble threshold may, at least in some embodiments, be user configurable. In a potentially overlapping set of embodiments, a value of the preamble threshold is varied during operation of the radio receiver. This may, for example, advantageously allow the radio receiver to vary the threshold that the preamble sub-frame's signal strength must meet in order for the receiver to continue monitoring the search space candidates as may be required.

Those skilled in the art will appreciate that in some communication protocols such as eMTC, transmissions may use one of a plurality of antenna ports. In some embodiments of any of the foregoing aspects, the method comprises:
monitoring the plurality of search space candidates for each of a plurality of antenna port hypotheses;
determining a first antenna port received signal strength value for a first antenna port hypothesis;
determining a second antenna port received signal strength value for a second antenna port hypothesis;
comparing said first and second antenna port received signal strength values; and
stopping monitoring of search space candidates associated with the first antenna port hypothesis that overlap with one or more search space candidates associated with the second antenna port hypothesis when the first antenna port received signal strength value is less than the second antenna port received signal strength value by a predetermined threshold.

This is novel and inventive in its own right and thus when viewed from a fourth aspect, the invention provides a method of operating a radio receiver in accordance with a protocol, said method comprising:
monitoring a plurality of search space candidates for each of a plurality of antenna port hypotheses;
determining a first antenna port received signal strength value for a first antenna port hypothesis;
determining a second antenna port received signal strength value for a second antenna port hypothesis;
comparing said first and second antenna port received signal strength values; and
stopping monitoring of search space candidates associated with the first antenna port hypothesis that overlap with one or more search space candidates associated with the second antenna port hypothesis when the first antenna port received signal strength value is less than the second antenna port received signal strength value by a predetermined threshold.

This fourth aspect of the invention extends to a radio receiver arranged to operate in accordance with a protocol, said radio receiver being further arranged to:
monitor a plurality of search space candidates for each of a plurality of antenna port hypotheses;
determine a first antenna port received signal strength value for a first antenna port hypothesis;
determine a second antenna port received signal strength value for a second antenna port hypothesis;
compare said first and second antenna port received signal strength values; and
stop monitoring of search space candidates associated with the first antenna port hypothesis that overlap with one or more search space candidates associated with the second antenna port hypothesis when the first antenna port received signal strength value is less than the second antenna port received signal strength value by a predetermined threshold.

This fourth aspect of the invention also extends to a radio communication system comprising a radio transmitter and a radio receiver arranged to operate in accordance with a protocol, said radio receiver being further arranged to:
monitor a plurality of search space candidates for each of a plurality of antenna port hypotheses;
determine a first antenna port received signal strength value for a first antenna port hypothesis;
determine a second antenna port received signal strength value for a second antenna port hypothesis;
compare said first and second antenna port received signal strength values; and
stop monitoring of search space candidates associated with the first antenna port hypothesis that overlap with one or more search space candidates associated with the second antenna port hypothesis when the first antenna port received signal strength value is less than the second antenna port received signal strength value by a predetermined threshold.

This fourth aspect of the invention further extends to a non-transitory computer-readable medium comprising instructions that, when executed by a processor, cause the process to carry out a method of operating a radio receiver arranged to operate in accordance with a protocol such that said radio receiver:
monitors a plurality of search space candidates for each of a plurality of antenna port hypotheses;
determines a first antenna port received signal strength value for a first antenna port hypothesis;
determines a second antenna port received signal strength value for a second antenna port hypothesis;
compares said first and second antenna port received signal strength values; and
stops monitoring of search space candidates associated with the first antenna port hypothesis that overlap with one or more search space candidates associated with the second antenna port hypothesis when the first antenna port received signal strength value is less than the second antenna port received signal strength value by a predetermined threshold.

Thus it will be appreciated that, in accordance with this fourth aspect of the invention, a radio receiver may determine that one or more of the search space candidates associated with one of the antenna port hypotheses may be removed from the search space (i.e. they are no longer monitored) because another antenna port hypothesis results in significantly better signal strength values.

Those skilled in the art will appreciate that the ‘predetermined threshold’ by which the second antenna port received signal strength value must exceed the first antenna port received signal strength value in order for monitoring of the candidates associated with the first antenna hypothesis will be a design decision and will represent a trade-off between power saving (by ceasing monitoring of candidates associated with a particular antenna port hypothesis) and reliability (because the radio receiver may inadvertently stop monitoring candidates that it should still be monitoring if the predetermined amount is too low).

In a set of embodiments of any of the foregoing aspects of the invention the radio receiver, or at least a portion thereof, enters a low power or sleep mode if it stops monitoring all currently remaining search space candidates.

In previous releases of the LTE standard, a UE has not been able to utilise CRS for MPDCCH channel estimates. However, Release 16 of the LTE standard introduced a feature in which a predetermined mapping may exist between CRS and DM RS antenna ports, such that a UE has a priori knowledge of the mapping between these antenna ports. This prior knowledge allows the UE to combine the channel estimates obtained from CRS and DMRS signals.

In a set of embodiments of any of the foregoing aspects of the invention, the portion specified in the protocol for carrying a non-universal reference symbol may be combined with the universal reference symbol to generate a combined portion, wherein a combined received signal strength value is determined from the combined portion, where the combined received signal strength value is used in place of the first received signal strength value in the subsequent comparisons and determinations.

In other words, in some embodiments the method comprises:
combining the portion specified in the protocol for carrying a non-universal reference symbol with the universal reference symbol to generate a combined portion;
determining a combined received signal strength value of said combined portion;
comparing the combined received signal strength value to a signal strength threshold based on the second received signal strength value;
operating the radio receiver in the normal mode if the combined received signal strength value exceeds the signal strength threshold; and
operating the radio receiver in the rejection mode if the combined received signal strength value does not exceed the signal strength threshold.

Thus, in accordance with such embodiments, a determination may be made as to the presence of incoming data symbols addressed to the radio receiver using this combined signal strength value. The Applicant has appreciated that if the non-universal reference symbol (e.g. DMRS) is present, combining that non-universal symbol with the universal reference symbol (e.g. CRS) improves the SNR compared to the SNR of the universal reference symbol alone. If the combined signal strength value is less than the threshold determined by the second signal strength value, i.e. combining the portion for the non-universal reference symbol with the universal reference symbol results in a sufficiently reduction in SNR compared to the SNR of the universal reference symbol alone, this may indicate that there is no non-universal reference symbol present and accordingly no data symbols addressed to the radio receiver, e.g. a DCI message. As before, the receiver may then stop monitoring one or more search space candidates earlier than it would have otherwise done, thereby saving power.

This is novel and inventive in its own right and thus, when viewed from a fifth aspect, the present invention provides a method of operating a radio receiver in accordance with a protocol, the radio receiver having a normal mode in which said radio receiver is arranged to seek information by continually monitoring a plurality of search space candidates and a rejection mode in which said radio receiver stops monitoring one or more of said candidates, said method comprising:
receiving at least one signal comprising a portion specified in the protocol for carrying a non-universal reference symbol;
receiving at least one signal carrying a universal reference symbol;
combining the portion specified in the protocol for carrying a non-universal reference symbol with the universal reference symbol to generate a combined portion;
determining a combined received signal strength value of said combined portion;
determining a second received signal strength value of said universal reference symbol;
comparing the combined received signal strength value to a signal strength threshold based on the second received signal strength value;
operating the radio receiver in the normal mode if the combined received signal strength value exceeds the signal strength threshold; and
operating the radio receiver in the rejection mode if the combined received signal strength value does not exceed the signal strength threshold.

This fifth aspect of the invention extends to a radio receiver arranged to operate in accordance with a protocol, the radio receiver having a normal mode in which said radio receiver is arranged to seek information by continually monitoring a plurality of search space candidates and a rejection mode in which said radio receiver is arranged to stop monitoring one or more of said candidates, said radio receiver being further arranged to:
receive at least one signal comprising a portion specified in the protocol for carrying a non-universal reference symbol;
receive at least one signal carrying a universal reference symbol;
combine the portion specified in the protocol for carrying a non-universal reference symbol with the universal reference symbol to generate a combined portion;
determine a combined received signal strength value of said combined portion;
determine a second received signal strength value of said universal reference symbol;
compare the combined received signal strength value to a signal strength threshold based on the second received signal strength value;
operate in the normal mode if the combined received signal strength value exceeds the signal strength threshold; and
operate in the rejection mode if the combined received signal strength value does not exceed the signal strength threshold.

This fifth aspect of the invention also extends to a radio communication system comprising a radio transmitter and a radio receiver arranged to operate in accordance with a protocol, the radio receiver having a normal mode in which said radio receiver is arranged to seek information by continually monitoring a plurality of search space candidates and a rejection mode in which said radio receiver stops monitoring one or more of said candidates, said radio receiver being further arranged to:
receive at least one signal comprising a portion specified in the protocol for carrying a non-universal reference symbol;
receive at least one signal carrying a universal reference symbol;
combine the portion specified in the protocol for carrying a non-universal reference symbol with the universal reference symbol to generate a combined portion;
determine a combined received signal strength value of said combined portion;
determine a second received signal strength value of said universal reference symbol;
compare the combined received signal strength value to a signal strength threshold based on the second received signal strength value;
operate in the normal mode if the combined received signal strength value exceeds the signal strength threshold; and
operate in the rejection mode if the combined received signal strength value does not exceed the signal strength threshold.

This fifth aspect of the invention further extends to a non-transitory computer-readable medium comprising instructions that, when executed by a processor, cause the process to carry out a method of operating a radio arranged to operate in accordance with a protocol such that said radio receiver:

receive at least one signal comprising a portion specified in the protocol for carrying a non-universal reference symbol;
receives at least one signal carrying a universal reference symbol;
combines the portion specified in the protocol for carrying a non-universal reference symbol with the universal reference symbol to generate a combined portion;
determines a combined received signal strength value of said combined portion;
determines a second received signal strength value of said universal reference symbol;
compares the combined received signal strength value to a signal strength threshold based on the second received signal strength value;
operates in the normal mode if the combined received signal strength value exceeds the signal strength threshold; and
operates in the rejection mode if the combined received signal strength value does not exceed the signal strength threshold.

### BRIEF DESCRIPTION OF DRAWINGS

Certain embodiments of the invention will now be described, by way of example only, with reference to the accompanying drawings in which:

FIG. 1 is a schematic diagram of a radio receiver;

FIG. 2 is a flowchart illustrating a method of operating the radio receiver of FIG. 1 to determine from a preamble sub-frame whether to monitor the paging channel in accordance with an embodiment of the present invention;

FIG. 3 is a flowchart illustrating a method of operating the radio receiver of FIG. 1 to determine whether a failed decoding attempt was due to poor signal strength or because there are no paging DCI messages in accordance with an embodiment of the present invention;

FIG. 4 is a flowchart illustrating a method of operating the radio receiver of FIG. 1 to determine whether any paging DCI messages are present in accordance with an embodiment of the present invention;

FIG. 5 is a flowchart illustrating a method of operating the radio receiver of FIG. 1 to determine whether candidates associated with a particular antenna port hypothesis may not require monitoring in accordance with an embodiment of the present invention;

FIG. 6 is a flowchart illustrating a method of operating the radio receiver of FIG. 1 combining the methods shown in FIGS. 2 to 5;

FIG. 7 is a flowchart illustrating a method of checking to ensure that the determination made in the method of FIG. 3 is correct;

FIG. 8 is a flowchart illustrating a method of checking to ensure that the determination made in the method of FIG. 4 is correct; and

FIG. 9 is a flowchart illustrating a method of operating the radio receiver of FIG. 1 to determine whether any paging DCI messages are present in accordance with a further embodiment of the present invention.

### DETAILED DESCRIPTION

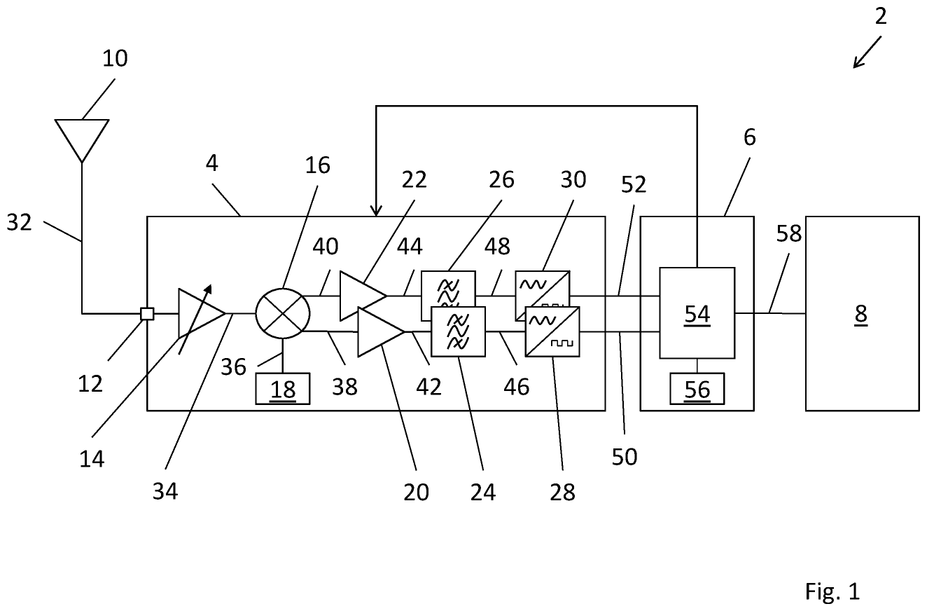

FIG. 1 is a block diagram of an LTE radio receiver device 2 (or User Equipment, ‘UE’ as used interchangeably hereinafter). The receiver 2 is implemented as a system-on-chip (SoC) and comprises: a front-end circuit portion 4; a digital circuit portion 6; and a further circuit portion 8. The structure and operation of each of these circuit portions 4, 6, 8 are described in turn below.

The analogue RF front-end circuit portion 4 is arranged to be connected to an antenna 10 via an antenna terminal 12 for receiving LTE radio signals received over-the-air. The front-end circuit portion 4 comprises: a variable gain pre-amplifier 14; a mixer 16; a local oscillator 18; an in-phase amplifier 20; a quadrature amplifier 22; two bandpass filters 24, 26; an in-phase analogue-to-digital converter (ADC) 28, and a quadrature ADC 30.

When an incoming LTE radio signal 32 is received via the antenna 10, it is first input to the variable gain pre-amplifier 14 which amplifies the signal 32 to a level suitable for processing by downstream circuitry. Typically, the variable gain pre-amplifier 14 is a low-noise amplifier (LNA), a type of amplifier known in the art per se that is particularly suited to amplifying a signal of interest while rejecting unwanted noise.

The resulting amplified signal 34 is input to the mixer 16, which is also arranged to receive a signal 36 generated by the local oscillator 18 as a further input. The signal 36 generated by the local oscillator 18 is set to the frequency of interest (i.e. the carrier frequency associated with the channel to which the receiver 2 is currently tuned). This downmixes the amplified signal 34 to baseband and also splits the signal into an in-phase signal 38 and a quadrature signal 40.

The in-phase signal 38 and the quadrature signal 40 are passed through the in-phase amplifier 20 and the quadrature amplifier 22 respectively to provide further amplification of each of these signals 38, 40. The resulting amplified in-phase signal 42 and amplified quadrature signal 44 are each passed through a respective band-pass filter 24, 26, where the bandpass filters 24, 26 are tuned to reject signals outside a particular frequency range. This results in a filtered in-phase signal 46 and a filtered quadrature signal 48.

The filtered in-phase and quadrature signals 46, 48 are input to the in-phase ADC 28 and the quadrature ADC 30 respectively. These ADCs 28, 30 convert the analogue filtered signals 46, 48 to a digital in-phase signal 50 and a digital quadrature signal 52. The resulting digital signals 50, 52 are then input to the digital circuit portion 6.

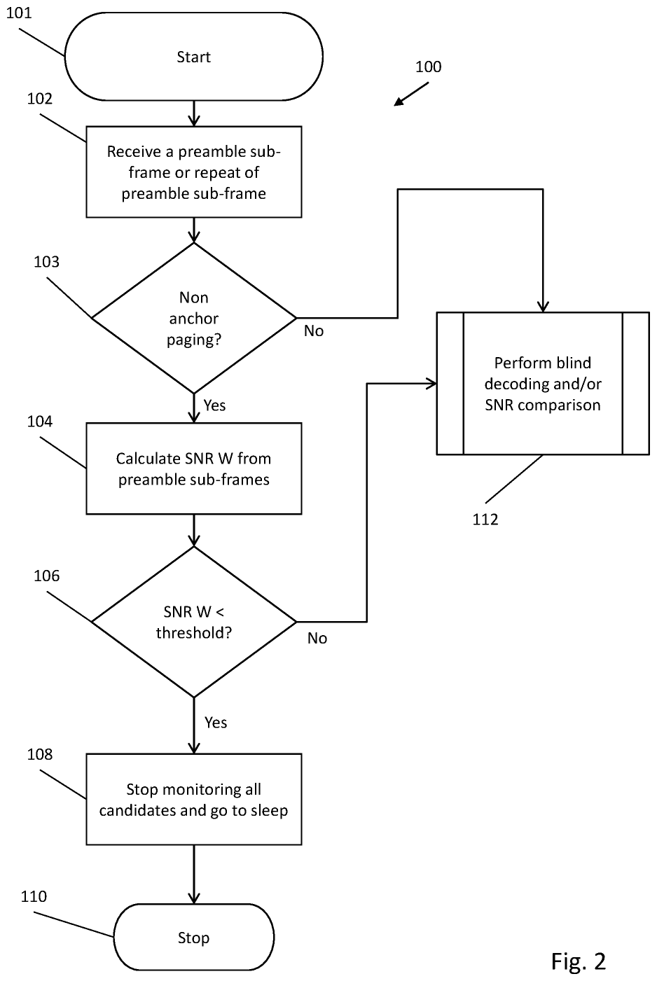

The digital circuit portion 6 includes a processor 54 which is connected to a memory 56. The processor is arranged to carry out digital processing of the digital signals 50, 52 in order to decode them, i.e. to retrieve the data within the received sub-frame. The processor 54 may store received sub-frames in the memory 56. The processor 54 is arranged to combine a number of stored sub-frames as outlined below with reference t FIG. 2. Once the processor 54 decodes the received sub-frame, the resulting data 58 is typically passed to the downstream circuitry 8, which will, under normal operation, use the data, e.g. received DCI messages, for various applications.

FIG. 2 is a flowchart illustrating a method of operating the LTE radio receiver 2 of FIG. 1. As explained below, during this process 100, the LTE radio receiver 2 is arranged to determine early that it does not need to monitor the paging channel if that is the case.

After the process 100 initially begins at step 101, the LTE radio receiver 2 receives a preamble sub-frame or repeat of a preamble sub-frame at step 102. This preamble sub-frame is a sub-frame typically having predefined content that arrives earlier in time than one or more further sub-frames e.g. those that contain data.

Once the preamble sub-frame has been received at step 102, the LTE radio receiver 2 determines whether non-anchor paging is in use at step 103. Those skilled in the art will appreciate that ‘non-anchor paging’ is a feature, introduced for NB-IoT in Release 14, in which the NRS is transmitted only if paging DCI exists for one or more UEs in the same paging group. Generally, there is a preamble of 10 sub-frames in which the NRS is transmitted. This NRS is generally transmitted during the DCI candidate, and four sub-frames after the transmission.

If the LTE radio receiver 2 determines at step 103 that non-anchor paging is in use, the LTE radio receiver 2 calculates an SNR, W from the preamble sub-frames at step 104. This SNR W may be determined in any manner known in the art per se.

Once the SNR W has been calculated at step 104, the LTE radio receiver compares the SNR W to a threshold at step 106.

If the SNR W is less than a pre-determined threshold value, then the process 100 proceeds to step 108 where the LTE radio receiver 2 stops monitoring all candidates and goes to sleep. After the LTE radio receiver 2 stops monitoring the candidates, this process 100 is stopped 110. This would typically represent the situation whereby the transmission does not contain any relevant signals. The ability to go to sleep immediately allows for a significant power saving over monitoring a large number of repetitions.

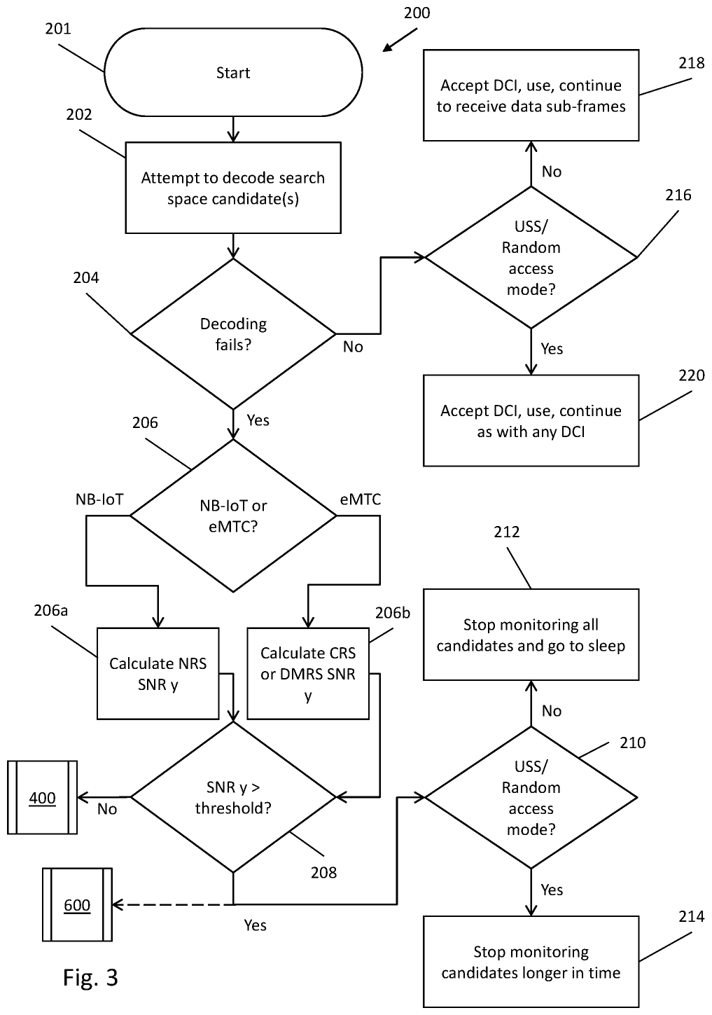

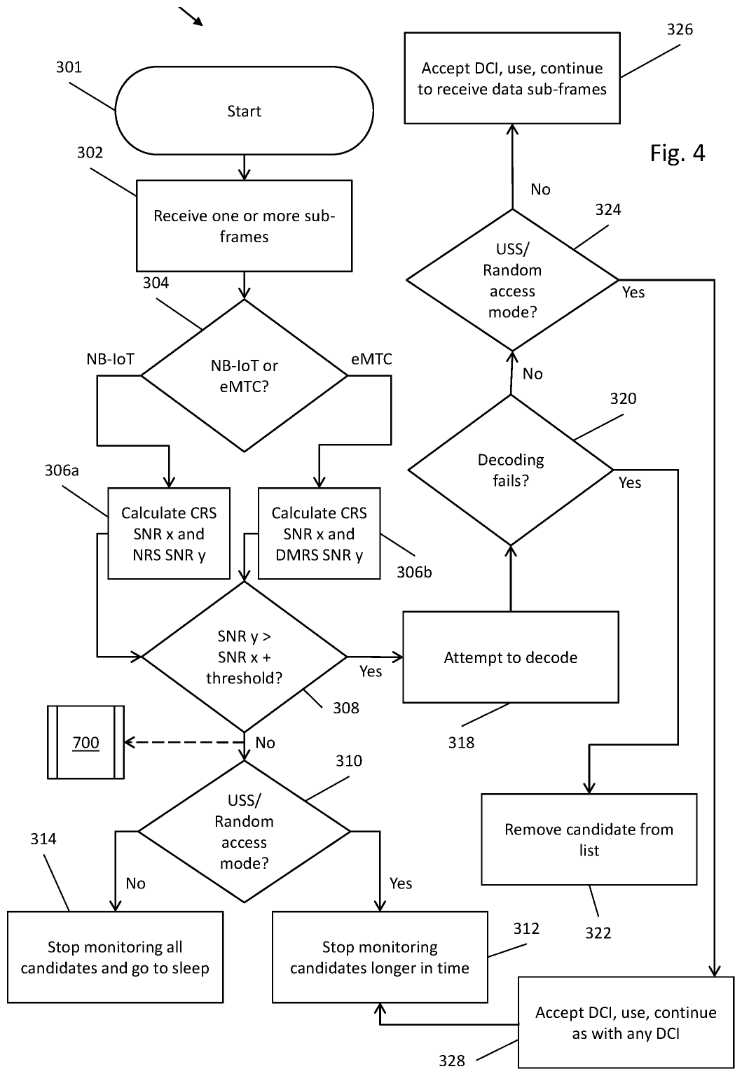

If it is determined at step 103 that non-anchor paging is not in use, or if at step 106 the SNR W is determined to be greater than the pre-determined threshold value, the process 100 instead proceeds to performing a blind decoding or SNR comparison process 112 as will be described below. While this process 112 may include carrying out blind decoding and/or SNR comparison techniques known in the art per se, this process 112 may instead involve carrying out one or both of the processes 200, 300 described below with reference to FIGS. 3 and 4 respectively.

Thus detection of NRS during the preamble is carried out by calculating the SNR of the preamble. NRS symbols may be accumulated and compared with a previously calculated SNR. If accumulation increases the SNR, NRS is assumed to exist and thus the NPDCCH is assumed to exist. Else, monitoring may be stopped.

FIG. 3 is a flowchart illustrating a method of operating the LTE radio receiver 2 of FIG. 1 in accordance with a further embodiment of the present invention or an extension of the previously described embodiment. In the process 200 shown in the flowchart of FIG. 3, the LTE radio receiver 2 is arranged to determine whether a failed decoding attempt was due to poor signal strength or, instead, because there are no paging DCI messages destined for the LTE radio receiver 2.

This process 200 starts at step 201 and assumes that the LTE radio receiver 2 has already received data symbols and so the LTE radio receiver 2 is ready to attempt decoding one or more search space candidates.

At step 202 the LTE radio receiver attempts to decode one or more search space candidates, e.g. using the processor 54 described herein above with reference to FIG. 1 by using any of a wide variety of known techniques such as using a Viterbi decoder.

The LTE radio receiver 2 determines at step 204 whether the decoding attempt has failed. Checking whether the decoding has failed at step 204 may be carried out using any techniques for checking whether decoding is successful or not known in the art per se. For example, a cyclic redundancy check (CRC) may be carried out to determine whether the result of the decoding attempt is valid.

If the decoding attempt is determined to have failed at step 204, a determination is made at step 206 as to whether NB-IoT or eMTC is in use. It will be appreciated that the determination as to which of these protocols is in use may not form part of the process 200 itself, but is shown here for ease of illustration. Typically for a given device the protocol will be fixed and so this choice would be predetermined.

If NB-IoT is in use, the LTE radio receiver 2 calculates an NRS SNR y from the NRS symbols that the LTE radio receiver 2 has received. Alternatively, if eMTC is in use, the LTE radio receiver 2 calculates a CRS or DMRS SNR y at step 206b. Thus, regardless of whether NB-IoT of eMTC is in use, the LTE radio receiver 2 calculates a SNR y based on the signal strength of a particular type of reference symbol. The reference symbol for which the SNR y is calculated may be a non-universal reference symbol (e.g. NRS for NB-IoT or DM RS for eMTC) or a universal reference symbol (e.g. CRS for eMTC or the In-Band mode of NB-IoT).

Once this SNR y has been calculated at step 206a or 206b as appropriate, the LTE radio receiver 2 compares the SNR y to a threshold at step 208. This threshold value may be a pre-determined value, e.g. that is set during calibration. Alternatively, this threshold may be configurable.

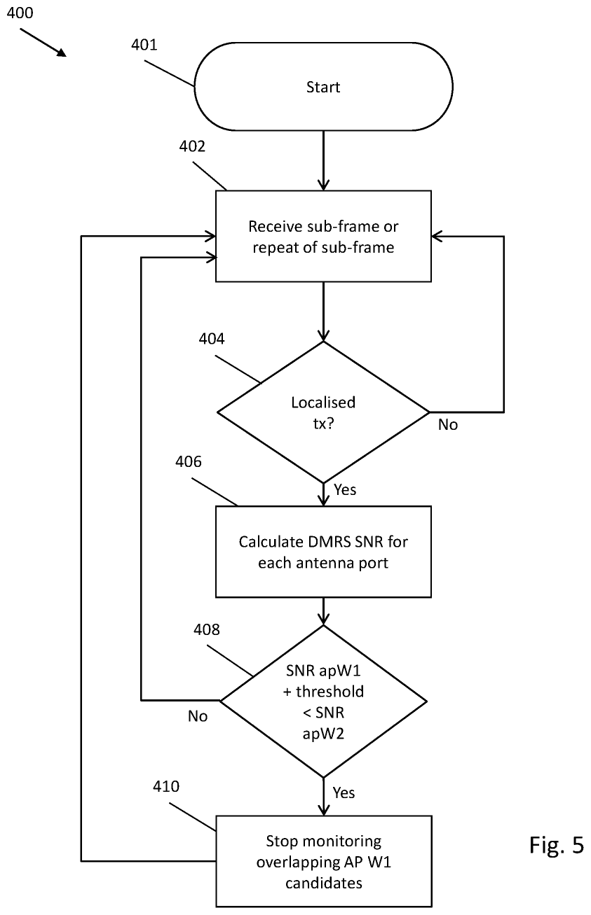

If the SNR y is not greater than the threshold value, a further process 400, described below with reference to FIG. 5, may be carried out as described below, however it is not essential to the process 200 described in the flowchart of FIG. 3.

Conversely, if the SNR y is greater than the threshold value when the determination is made at step 208, the LTE radio receiver 2 determines at step 210 whether the received data symbols correspond to a paging DCI message (i.e. whether the received data symbols, if sent by the network, should correspond to a paging occasion) or whether an unstructured mode such as a UE-specific search space (USS) or ‘random access’ mode is in use (i.e. the LTE radio receiver 2 does not know whether the received data symbols correspond to a paging occasion). If the LTE radio receiver 2 determines at step 210 that the unstructured mode is not in use and thus that it has received a paging DCI message having an SNR y greater than the threshold but that does not decode successfully, the LTE radio receiver 2 stops monitoring all candidates and goes to sleep at step 212. This would indicate that the DCI message is not intended for the particular UE and that this is why decoding failed, rather than simply that the signal was too weak to receive reliably.

Conversely, if the LTE radio receiver 2 determines at step 210 that the unstructured mode is in use, it stops monitoring all current overlapping candidates that are longer in time at step 214. Monitored candidates may be of different lengths but share the same physical resources. If the LTE radio receiver 2 detects that there is no control channel in certain resources, then the monitoring of a candidate that uses those same physical resources, at that point in time, can be stopped.

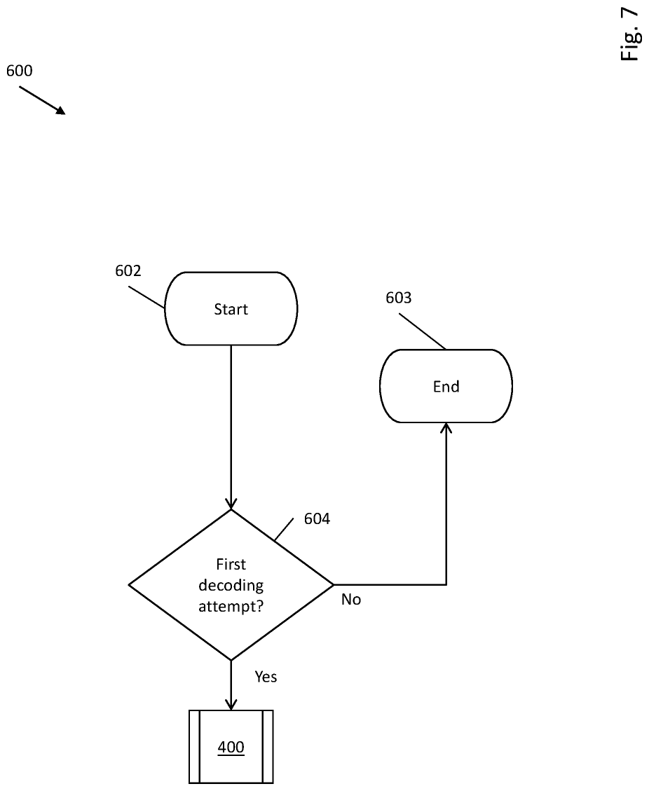

In some embodiments, an additional re-check process 600 may be carried out when the SNR y is determined to be greater than the threshold at step 208. This process 600 is discussed in further detail below with reference to FIG. 7, however it is not essential to the process 200 described in the flowchart of FIG. 3.

If at step 204, the decoding process does not fail, the LTE radio receiver 2 determines at step 216 whether the unstructured mode referred to above is in use. If the LTE radio receiver 2 determines at step 216 that the unstructured mode is not in use and thus that it has received a paging DCI message that has been successfully decoded, the LTE radio receiver 2 accepts the DCI and uses it, and continues to receive further data sub-frames at step 218. Conversely, if the LTE radio receiver 2 determines at step 216 that the unstructured mode is in use, the LTE radio receiver accepts the DCI, uses it, and continues as it would with any other DCI at step 220.

FIG. 4 is a flowchart illustrating a method of operating the LTE radio receiver 2 of FIG. 1 in accordance with a further embodiment of the present invention or an extension of any of the embodiments previously described. The process 300 shown in the flowchart of FIG. 4 is a process by which the LTE radio receiver 2 may determine the presence of any DCI messages early in the decoding process.

Once the process 300 is started at step 301, the LTE radio receiver 2 receives one or more sub-frames at step 302. A determination is made at step 304 as to whether NB-IoT or eMTC is in use. As discussed above, it will be appreciated that the determination made at step 304 may or may not form part of the process 300, and the LTE radio receiver 2 may already know in advance which of these protocols it is to operate in accordance with, or, in some arrangements, the LTE radio receiver 2 may only be arranged to carry out communications in accordance with one of these protocols.

If NB-IoT is in use, at step 306a the LTE radio receiver 2 calculates a CRS SNR x and an NRS SNR y. As will be appreciated, in accordance with LTE, CRS are transmitted continually in all circumstances to all UEs and may thus be considered universal reference symbols. NRS are only transmitted for specific UEs or paging groups and are thus non-universal reference symbols.

Conversely, if eMTC is in use, the radio receiver 2 calculates a CRS SNR x and a DMRS SNR y at step 306b. Like NRS, DMRS are only transmitted for specific UEs or paging groups and are thus non-universal reference symbols. Thus it can be seen that, regardless of whether NB-IoT or eMTC is in use, the LTE radio receiver 2 determines a first received signal strength value (i.e. SNR x) which corresponds to the signal strength of a received universal reference symbol, i.e. CRS, and a second received signal strength value (i.e. SNR) of a non-universal reference symbol, i.e. NRS or DMRS.

Once these SNR values x, y have been determined at step 306a or step 306b, the LTE radio receiver 2 compares these SNR values x, y at step 308. If the SNR value y associated with the NRS or DMRS is not greater than the SNR x of the CRS by more than a particular threshold amount, this means that the portion of the transmission which should contain the more specific reference symbols is not sufficiently strong when judged against the universal CRS ‘benchmark’ which suggests that such symbols are not present in the transmission and so it is unlikely to contain DCI of any sort. Although in this embodiment a simple comparison between the SNR values is performed, the SNR value y associated with the NRS or DMRS could instead be compared with a signal strength threshold based on the SNR of the CRS but also taking into account e.g. a known power offset of known transmit antenna mapping difference between them.

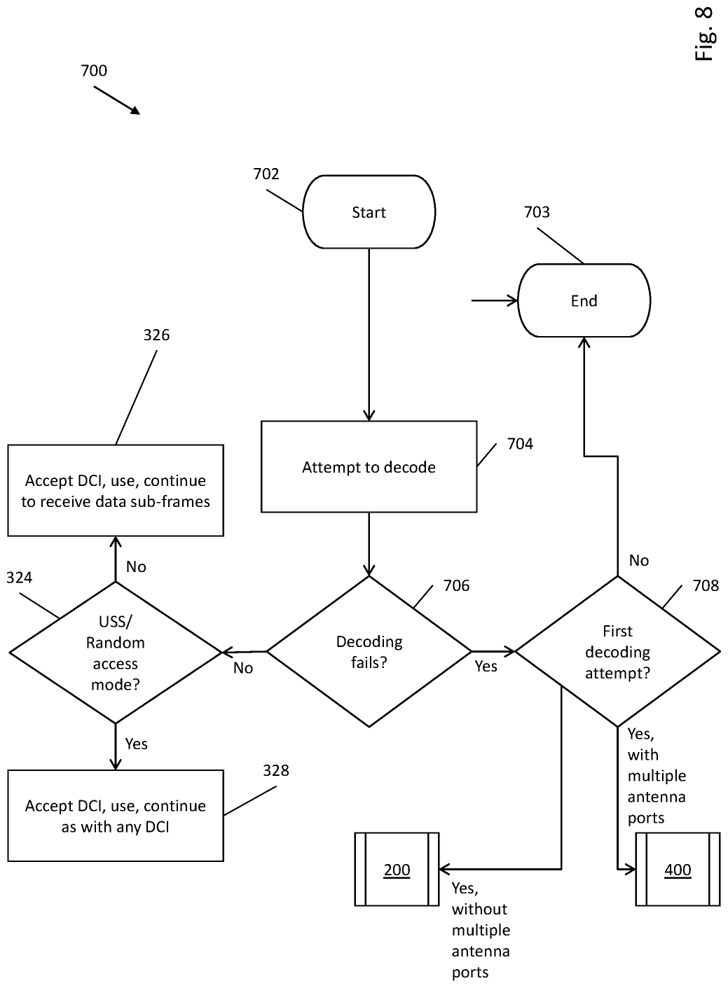

The LTE radio receiver then determines at step 310 whether the received sub-frames are expected to be a paging DCI message by checking whether the random access mode is in use. An optional re-check process 700 may be carried out at this stage, as described with reference to FIG. 8, however this process 700 is not essential to the process 300 described with reference to FIG. 4.

If, at step 310, the LTE radio receiver determines that the USS mode or the random access mode (i.e. an ‘unstructured’ mode) is in use, the LTE radio receiver 2 stops monitoring all current overlapping candidates longer in time at step 312 since these cannot now be successfully decoded.

Conversely, if the LTE radio receiver 2 determines at step 310 that neither the USS mode nor the random access mode is in use (i.e. that the LTE radio receiver device 2 is in the paging monitoring mode), the LTE radio receiver 2 stops monitoring all current candidates and goes to sleep at step 314.

If, however, the LTE radio receiver 2 determines at step 308 that the SNR value y associated with the NRS or DMRS is greater than the SNR x of the CRS by more than the threshold amount, indicating that non-universal reference symbols are present, an attempt to decode the received sub-frame(s) is made at step 318. A determination is made at step 320 as to whether the decoding has failed e.g. using a CRC. If the decoding attempt fails, the candidate is removed from the list of viable candidates at step 322 because while the strength of the received non-universal reference symbol (i.e. NRS or DM RS) relative to the universal reference symbol (i.e. CRS) indicates the potential presence of a DCI message, the failed decoding attempt indicates that the message does not correspond to the decoding candidate being tested e.g. because it is intended for another paging group. Decoding attempts may be made for several different candidates at step 318.

If, on the other hand, the decoding attempt is deemed a success (i.e. does not fail) at step 320, a further determination is made at step 324 regarding whether the successfully decoded message is expected to be a paging DCI message by determining whether or not the random access mode is in use. If the decoded message is a paging DCI message (i.e. the random access mode is not in use), the LTE radio receiver 2 accepts the DCI, uses it, and continues to receive data sub-frames at step 326.

Conversely, if the USS mode or random access mode is in use, the LTE radio receiver 2 accepts the DCI and uses it, and continues as with any DCI at step 328 and stops monitoring of all overlapping candidates longer in time at step 312.

FIG. 5 is a flowchart illustrating a further method of operating the LTE radio receiver 2 of FIG. 1 in accordance with a further embodiment of the present invention or extension of one of the previous embodiments. The process 400 shown in FIG. 5 may thus be carried out independently, or it may be carried out after carrying out one or both of the processes 200, 300 described above. This process 400 operates the LTE radio receiver 2 so as to determine whether candidates associated with a particular antenna port hypothesis may not require monitoring in favour of candidates associated with a further antenna port hypothesis. This process 400 is particularly advantageous when the LTE radio receiver 2 is arranged to operate in accordance with the eMTC protocol which allows for such hypotheses.

Once the process 400 is started at step 401, the LTE radio receiver 2 receives a sub-frame or a repeat of a sub-frame at step 402. Once the sub-frame has been received at step 402, the LTE radio receiver 2 determines at step 404 whether the received sub-frame corresponds to a localised transmission at step 404. Those skilled in the art will appreciate that the ‘localised transmission mode’ is a mode that may be used in the USS mode of the eMTC protocol (thus this check also implicitly checks whether eMTC is in use). Whether or not this is in use is generally known the LTE radio receiver 2 in advance and so no determination is typically made during operation, but is shown here for illustrative purposes.

If the LTE radio receiver 2 determines at step 404 that it is not a localised transmission, the process 400 returns to step 402 and a further sub-frame or repeat of a sub-frame is received.

Conversely, if the LTE radio receiver 2 determines at step 404 that it is a localised transmission, then the LTE radio receiver 2 calculates a DMRS SNR for each antenna port at step 406. It will be appreciated that, at least in eMTC systems, transmissions from the network may be carried out using one of many different antenna ports. For ease of reference, in this example, the LTE radio receiver 2 may receive transmissions on a first antenna port AP W1 or on a second antenna port AP W2, however it is not known in advance which antenna port the network is currently using. Thus, for each antenna port hypothesis, the LTE radio receiver 2 calculates a corresponding SNR value.

Once these DMRS SNR values have been calculated at step 406, the LTE radio receiver 2 compares the SNR values for each of the two antenna port hypotheses at step 408. If the SNR, apW1 associated with the first antenna port hypothesis is less than the SNR, apW2 associated with the second antenna port hypothesis by more than a threshold amount, the LTE radio receiver 2 stops monitoring overlapping candidates associated with the first antenna port AP W1 at step 410 because it assumes that the first antenna port hypothesis must be wrong. Otherwise, the process 400 returns to step 402 and further sub-frames are received. Once monitoring of overlapping candidates has been stopped at step 410, the process 400 returns to step 402 and further sub-frames are received.

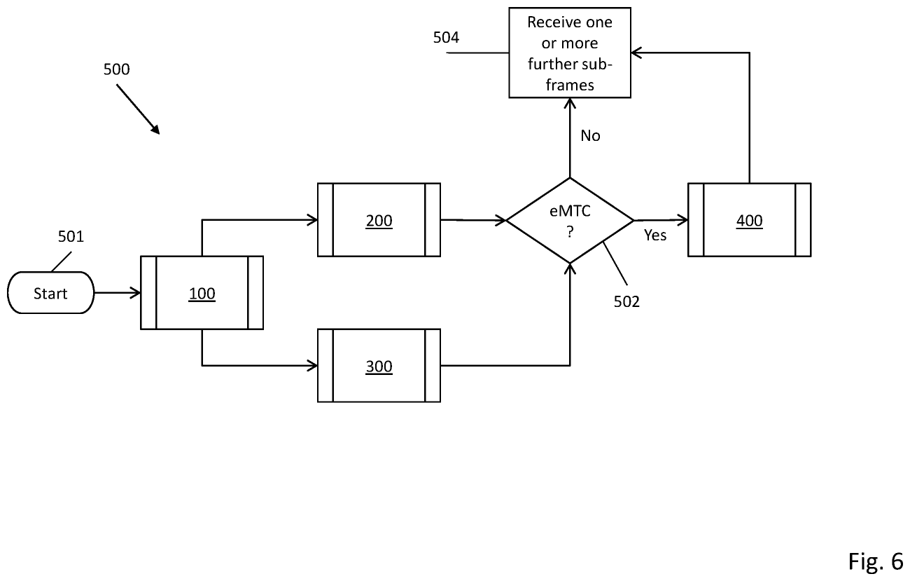

FIG. 6 is a flowchart illustrating a method of operating the radio receiver of FIG. 1 combining the methods shown in FIGS. 2 to 5. Once the process 500 shown in FIG. 6 is started at step 501, the LTE radio receiver 2 first carries out the process 100 described hereinabove with reference to FIG. 2. The LTE radio receiver 2 may, while carrying out that process 100, also carry out the optional ‘re-checking’ process 600 described below with reference to FIG. 7.

Providing the SNR W calculated from the preamble sub-frame(s) is determined not to be less than the threshold at step 106, the process 100 of FIG. 2 proceeds to step 112 as explained above. In the embodiment described here with reference to FIG. 6, this step 112 involves carrying out the blind decoding process 100 of FIG. 3 in parallel with the SNR comparison process 200 of FIG. 4. It will, however, be appreciated that, in some alternative embodiments, only one of these may be carried out.

Once the blind decoding process 100 of FIG. 3 and the SNR comparison process 200 of FIG. 4 are complete, a determination is made at step 502 as to whether the LTE radio receiver 2 is operating in accordance with the eMTC protocol. If eMTC is in use, the antenna port hypothesis analysis process 400 described above with reference to FIG. 5 is carried out to determine whether the candidates associated with one or more antenna port hypotheses may not require monitoring. Once the antenna port hypothesis process 400 is complete, or if eMTC is not in use, one or more further sub-frames are subsequently received at step 504. Some or all of these monitoring steps may then be carried out on the subsequently received sub-frames.

Multiple sub-frames may be accumulated for processing, e.g. by one or more stages of the process 500, where appropriate.

FIG. 7 is a flowchart illustrating an optional method of checking to ensure that the determination made in the method of FIG. 3 is correct. The process 600 described with reference to FIG. 7 may be invoked during the blind decoding process 200 of FIG. 3 as described above.

If the SNR y is determined to be greater than the threshold at step 208 of the blind decoding process 200 after the decoding attempt has been deemed to have failed at step 206 of that process 200, the LTE radio receiver 2 may initiate 601 this optional ‘re-checking’ process 600.

After the process 600 is started at step 602, a further determination is made at step 604 as to whether the current decoding attempt (i.e. the decoding attempt of step 202 of the blind decoding process 200) is the first such attempt or whether multiple attempts have now failed. If the current decoding attempt is the first such attempt, the antenna port hypothesis process 400 described above is carried out.

Conversely, if the current decoding attempt is not the first failed decoding attempt, this optional re-checking process 600 ends 603 and the blind decoding process 200 of FIG. 3 resumes from step 210 onwards as described previously.

FIG. 8 is a flowchart illustrating a method of checking to ensure that the determination made in the method of FIG. 4 is correct. The process 700 described with reference to FIG. 8 may be invoked during the SNR comparison process 300 of FIG. 4 as described above.

If the SNR y of the non-universal reference symbol (e.g. NRS or DMRS as appropriate) is determined not to be greater than SNR x of the universal reference symbol (e.g. CRS) by more than the threshold amount at step 308 of the SNR comparison process 300, the LTE radio receiver 2 may initiate this optional ‘re-checking’ process 700.

After the process 700 is started at step 702, an attempt to decode the received sub-frame is made at step 704, e.g. using the processor 54 as described previously with reference to FIG. 1. A determination is subsequently made at step 706 as to whether the decoding attempt of step 704 has been successful.

If the decoding attempt is deemed to have failed from the determination made at step 706, a further determination is made at step 708 as to whether the current decoding attempt (i.e. the decoding attempt of step 704) is the first such attempt or whether multiple attempts have now failed. If the current decoding attempt is the first such attempt, either the antenna port hypothesis process 400 described above is carried out if a protocol that uses multiple antenna ports, such as eMTC, is in use; or the SNR comparison process 300 is tried once again once further sub-frames have been received (and optionally accumulated) if a process that does not use multiple antenna ports, such as NB-IoT, is in use.

Conversely, if the current decoding attempt is not the first failed decoding attempt, this optional re-checking process 700 ends 703 and the SNR comparison process 300 of FIG. 4 resumes from step 310 onwards as described previously.

If, however, the decoding attempt of step 704 is determined to have been successful at step 706, the re-checking process 700 diverts the process flow to step 324, which determines whether the received message is expected to be a paging DCI message or not as described above with respect to FIG. 4. If the decoded message is expected to be a paging DCI message, the LTE radio receiver 2 accepts the DCI, uses it, and continues to receive data sub-frames at step 326. Conversely, if the decoded message is not expected a paging DCI message, the LTE radio receiver 2 accepts the DCI and uses it, and continues as with any DCI at step 328 and stops monitoring of all candidates longer in time at step 312.

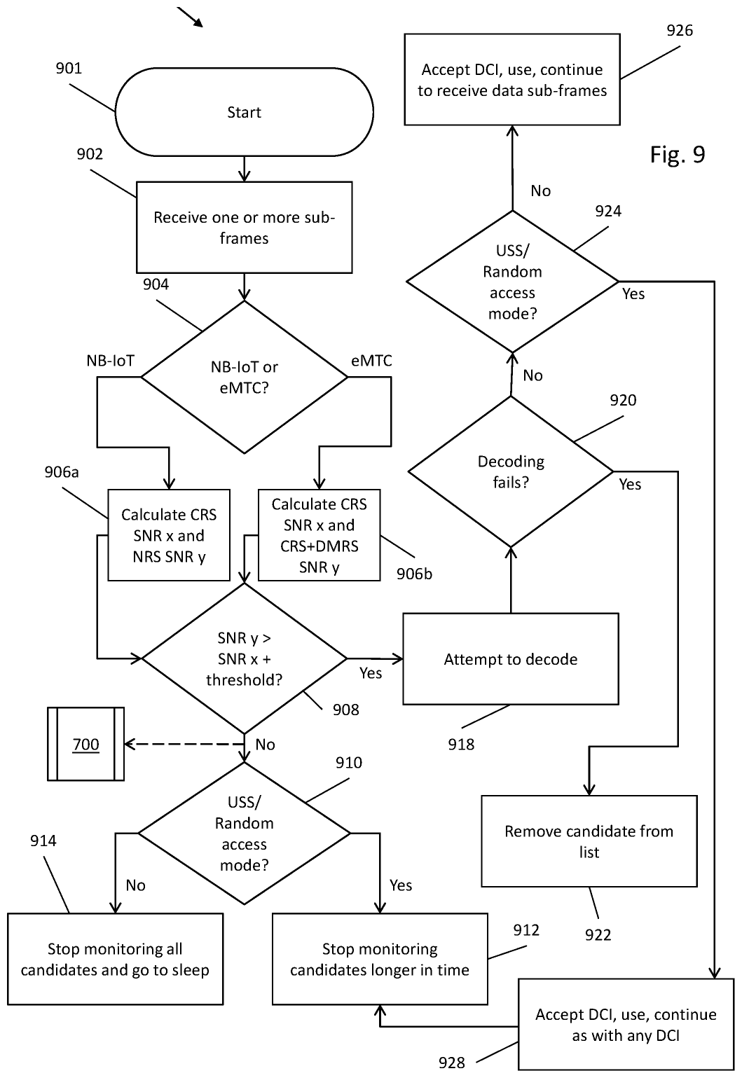

FIG. 9 is a flowchart illustrating a method of operating the radio receiver 2 of FIG. 1 to determine whether any paging DCI messages are present in accordance with a further embodiment of the present invention. This method may, by way of non-limiting example, advantageously be used in LTE systems compliant with Release 16 of the LTE standard.

The process 900 shown in the flowchart of FIG. 9 is a process by which the LTE radio receiver 2 may determine the presence of any DCI messages early in the decoding process. This process shares many steps with the method described previously with reference to FIG. 4, where similar steps have similar reference numerals, starting with a ‘9’ rather than a ‘3’.

If NB-IoT is in use, operation is the same as described previously with reference to FIG. 4. However, if eMTC is in use, the radio receiver 2 calculates a CRS SNR x and a CRS+DMRS SNR y at step 906b. This CRS+DMRS SNR y is calculated by combining the signal portion dedicated for a non-universal reference symbol (e.g. DMRS) with the received universal reference symbol (e.g. CRS) to form a combined portion, and the SNR of this combination is measured.

Following this, the LTE radio receiver 2 compares the CRS+DMRS SNR value y to the SNR y of the CRS alone at step 908. If the SNR value y associated with the CRS+DMRS is not greater than the SNR x of the CRS by more than a particular threshold amount, this means that rather than aiding the SNR of the CRS, the addition of the portion associated with DM RS has sufficiently degraded the SNR of the CRS. This indicates that, in fact, no DMRS is present in the transmission and so the transmission is unlikely to contain DCI of any sort. The remainder of the process carries on as described previously with reference to FIG. 4.

Thus it will be appreciated by those skilled in the art that embodiments of the present invention provide an improved radio receiver that may determine whether there are any incoming signals destined for the receiver and, if not, ignore incoming signals and/or go to sleep, which may advantageously result in reduced power consumption compared to conventional radio receivers. It will be appreciated by those skilled in the art that the embodiments described above are merely exemplary and are not limiting on the scope of the invention.

1. A method of operating a radio receiver in accordance with a protocol, the radio receiver having a normal mode in which said radio receiver is arranged to seek information by continually monitoring a plurality of search space candidates and a rejection mode in which said radio receiver stops monitoring one or more of said candidates, said method comprising:
receiving at least one signal comprising a portion specified in the protocol for carrying a non-universal reference symbol;
determining a first received signal strength value of said portion;
receiving at least one signal carrying a universal reference symbol;
determining a second received signal strength value of said universal reference symbol;
comparing the first received signal strength value to a signal strength threshold based on the second received signal strength value;
operating the radio receiver in the normal mode if the first received signal strength value exceeds the signal strength threshold; and
operating the radio receiver in the rejection mode if the first received signal strength value does not exceed the signal strength threshold;
wherein the signal strength threshold is determined from the second received signal strength to account for a known power offset between the universal and non-universal reference symbols and/or for a known difference in a transmission antenna mapping between the non-universal and universal reference symbols.

2. The method as claimed in claim 1, wherein the signal strength threshold is the second received signal strength.

3. (canceled)

4. The method as claimed in claim 1, wherein the step of operating the radio receiver in the normal operating mode comprises:
performing a decoding attempt on a selected search space candidate of said one or more search space candidates.

5. The method as claimed in claim 4, wherein operating the radio receiver in the normal mode comprises subsequently stopping monitoring of the selected search space candidate if the decoding attempt fails.

6. The method as claimed in claim 5, further comprising:
receiving a further repetition of said selected search space candidate; and
said decoding attempt is a second or subsequent decoding attempt performed on said further repetition.

7. The method as claimed in claim 1, wherein operating the radio receiver in the normal mode comprises:
performing a decoding attempt on a selected search space candidate of said one or more search space candidates, wherein a successful decoding attempt produces a downlink control information message; and
accepting the downlink control information message if the decoding attempt is successful.

8. The method as claimed in claim 7, wherein operating the radio receiver in the normal mode further comprises:
determining whether an unstructured mode is enabled;
accepting the downlink control information message and subsequently receiving one or more data sub-frames if the decoding attempt is successful and the unstructured mode is not enabled; and
accepting the downlink control information message and subsequently stopping monitoring of all current search space candidates when the decoding attempt is successful and the unstructured mode is enabled.

9. The method as claimed in claim 1, wherein the first and/or second received signal strength values comprise a respective signal-to-noise ratio (SNR).

10. The method as claimed in claim 1, wherein the protocol comprises a machine to-machine LTE radio communication protocol.

11. The method as claimed in claim 10, wherein the protocol is NB-IoT and the non-universal reference symbol comprises a narrowband reference symbol (NRS).

12. The method as claimed in claim 10, wherein the protocol is eMTC and the non-universal reference symbol comprises a demodulation reference symbol (DMRS).

13. The method as claimed in claim 10, wherein the universal reference symbol comprises a common reference symbol (CRS).

14. The method as claimed in claim 1, further comprising:
performing a decoding attempt on at least one search space candidate;
calculating a candidate signal strength value associated with the at least one search space candidate and comparing said candidate signal strength value to a threshold; and
operating the radio receiver in the rejection mode if the search space candidate decoding attempt fails and the candidate signal strength value is greater than said threshold.

15-35. (canceled)

36. A radio receiver arranged to operate in accordance with a protocol, the radio receiver having a normal mode in which said radio receiver is arranged to seek information by continually monitoring a plurality of search space candidates and a rejection mode in which said radio receiver is arranged to stop monitoring one or more of said candidates, said radio receiver being further arranged to:
receive at least one signal comprising a portion specified in the protocol for carrying a non-universal reference symbol;
determine a first received signal strength value of said portion;
receive at least one signal carrying a universal reference symbol;
determine a second received signal strength value of said universal reference symbol;
compare the first received signal strength value to a signal strength threshold based on the second received signal strength value;
operate in the normal mode if the first received signal strength value exceeds the signal strength threshold; and
operate in the rejection mode if the first received signal strength value does not exceed the signal strength threshold;
wherein the signal strength threshold is determined from the second received signal strength to account for a known power offset between the universal and non-universal reference symbols and/or for a known difference in a transmission antenna mapping between the non-universal and universal reference symbols.

37. (canceled)

38. A non-transitory computer-readable medium comprising instructions that, when executed by a processor, cause the process to carry out a method of operating a radio arranged to operate in accordance with a protocol such that said radio receiver:
receives at least one signal comprising a portion specified in the protocol for carrying a non-universal reference symbol;
determines a first received signal strength value of said portion;
receives at least one signal carrying a universal reference symbol;
determines a second received signal strength value of said universal reference symbol;
compares the first received signal strength value to a signal strength threshold based on the second received signal strength value;
operates in the normal mode if the first received signal strength value exceeds the signal strength threshold; and
operates in the rejection mode if the first received signal strength value does not exceed the signal strength threshold;
wherein the signal strength threshold is determined from the second received signal strength to account for a known power offset between the universal and non-universal reference symbols and/or for a known difference in a transmission antenna mapping between the non-universal and universal reference symbols.

39-51. (canceled)
